(19) United States
(12) Patent Application Publication
(10) Pub. No.: US 2014/0375540 A1
(43) Pub. Date: Dec. 25, 2014

(54) SYSTEM FOR OPTIMAL EYE FIT OF HEADSET DISPLAY DEVICE

(71) Applicants: Nathan Ackerman, Seattle, WA (US); Andy Hodge, Palo Alto, CA (US); David Nister, Bellevue, WA (US)

(72) Inventors: Nathan Ackerman, Seattle, WA (US); Andy Hodge, Palo Alto, CA (US); David Nister, Bellevue, WA (US)

(21) Appl. No.: 13/925,643

(22) Filed: Jun. 24, 2013

(51) Int. Cl. G06F 3/01; G06F 3/16; G02B 27/00

(52) U.S. Cl. CPC G06F 3/013; G02B 27/0093; G06F 3/16
USPC 345/156

(57) ABSTRACT

A system and method are disclosed for sensing a position and/or angular orientation of a head mounted display device respect to a wearer's eyes, and to provide feedback for adjusting the position and/or angular orientation of the head mounted display device so as to be optimally centered and oriented with respect to the wearer's eyes.

### BACKGROUND

Mixed reality is a technology that allows holographic, or virtual, imagery to be mixed with a real world physical environment. A see-through, head mounted, mixed reality display device may be worn by a user to view the mixed imagery of real objects and virtual objects displayed in the user's field of view. In order to facilitate the illusion of three-dimensional depth, images of virtual objects are displayed independently to the left and right eyes by the head mounted display device with a small binocular disparity between the images. This binocular disparity is interpreted by the brain as indicative of a depth of the virtual object in the mixed reality environment.

It is desirable to precisely control both the position of a head mounted display device on a user's head and the binocular disparity of displayed images. Even small deviations in the position or binocular disparity can create a blurred image, discomfort and loss of the three-dimensional effect.

### SUMMARY

Embodiments of the present technology relate to a system and method for sensing a position of a head mounted display device respect to a wearer's eyes, and to provide feedback for adjusting the position of the head mounted display device so as to be optimally centered with respect to the wearer's eyes. In embodiments, a head mounted display device includes display units and an eye position and tracking assembly. The display units display images to optics over the left and right eyes with the appropriate ocular disparity to create the illusion of virtual objects at a given distance away from the user. The eye position and tracking assembly may include one or more light sources and one or more sensors which operate identify a position of a user's eyes with respect to the eye position and tracking assembly. The geometry of the eye position and tracking assembly relative to the display units is known so that the optimal, centered position of the display units may be determined for each eye.

When misalignment of the display units relative to a user's eyes is detected, the head mounted display device may provide visual and/or auditory feedback to the user. This feedback may instruct the user on how to adjust the head mounted display to optimally align and fit the head mounted display device over the user's eyes. In addition to providing feedback on adjustment of a position of the head mounted display, the current technology may provide feedback on adjusting the inter-pupillary distance (IPD) in the head mounted display device for embodiments where the head mounted display device has an adjustable IPD.

In an alternative embodiment, adjustment of the head mounted display device position and/or IPD may occur automatically. In one such automatic example, upon detection of misalignment, the misalignment may be corrected using software to adjust how and where virtual objects are displayed by one or both display units. In another automatic example, motors may be provided on the head mounted display device to adjust certain positions and/or IPD of the head mounted display device.

In an example, the present technology relates to a head mounted display device, comprising: a display unit including optical elements; a position and tracking assembly for sensing a position and angular orientation of the position and tracking assembly with respect to eyes of a wearer; a processor coupled to the display unit and position and tracking assembly for determining a position and angular orientation of the optical elements relative to the eyes; and a feedback routine executed by the processor for providing feedback to the wearer to adjust at least one of the position and orientation of the head mounted display device relative to the eyes based on the determination of misalignment from the processor.

In a further example, the present technology relates to a head mounted display device for providing a mixed reality experience in a space having an x-axis, a y-axis perpendicular to the x-axis and a z-axis perpendicular to the x and y axes, the head mounted display comprising: a display unit including optical elements for displaying virtual images to eyes of a wearer; a position and tracking assembly for sensing a position with respect to the x, y and z axes of the position and tracking assembly to the eyes, and an angular rotation with respect to rotation about the x, y and z axes an x-axis of the position and tracking assembly to the eyes; a processor coupled to the display unit and position and tracking assembly for determining a position and angular orientation of the optical elements relative to the eyes; and a feedback routine implemented by the processor for providing feedback to the user to adjust at least one of the position and orientation of the head mounted display relative to the eyes based on the determination from the processor.

In another example, the present technology relates to a method for indicating misalignment of one or more optical elements of a head mounted display device with eyes of a wearer, the method comprising: (a) determining misalignment of the optical elements to the eyes of the wearer, said misalignment determined by a processing device and an eye position and tracking assembly; and (b) generating feedback providing information to the wearer regarding how to adjust one or more of the optical elements, the feedback displayed as one or more virtual images displayed to the optical elements.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is an illustration of example components of one embodiment of a system for presenting a mixed reality environment to one or more users.

FIG. 2 is a perspective view of one embodiment of a head mounted display unit.

FIG. 3 is a side view of a portion of one embodiment of a head mounted display unit.

FIG. 4 is a block diagram of one embodiment of the components of a head mounted display unit.

FIG. 5 is a block diagram of one embodiment of the components of a processing unit associated with a head mounted display unit.

FIG. 6 is a flowchart illustrating operation of an embodiment of the present technology.

FIGS. 7-9 illustrate misalignments optical elements of a head mounted display device to eyes of a wearer.

FIGS. 10-12 illustrate views through a head mounted display device including virtual objects providing feedback on how to correct misalignments optical elements of a head mounted display device to eyes of a wearer.

FIG. 13 is a block diagram of one embodiment of a computing system that can be used to implement computing systems described herein.

### DETAILED DESCRIPTION

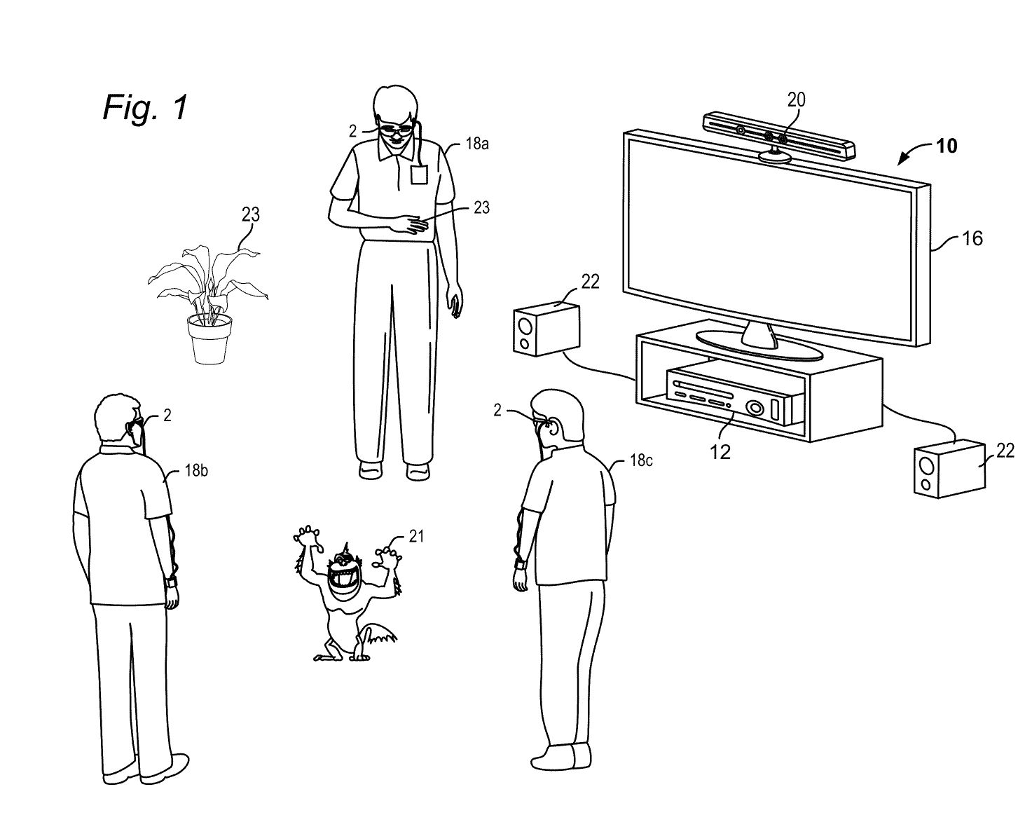

Embodiments of the present technology will now be described with reference to FIGS. 1-13 which in general relate to a system and method for sensing a position and/or angular orientation of a head mounted display device respect to a wearer's eyes, and to provide feedback for adjusting the position and/or angular orientation of the head mounted display device so as to be optimally centered and oriented with respect to the wearer's eyes. The head mounted display device may be used to implement a mixed reality environment including real and virtual objects. The head mounted display device may include a display element. The display element is to a degree transparent so that a user can look through the display element at real world objects within the user's field of view (FOV). The display element also provides the ability to project virtual images into the FOV of the user such that the virtual images may also appear alongside the real world objects. The system automatically tracks where the user is looking so that the system can determine where to insert the virtual image in the FOV of the user. Once the system knows where to project the virtual image, the image is projected using the display element.

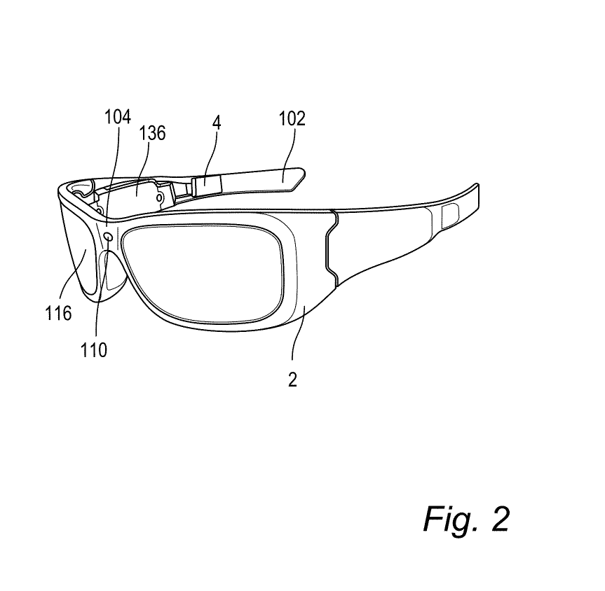

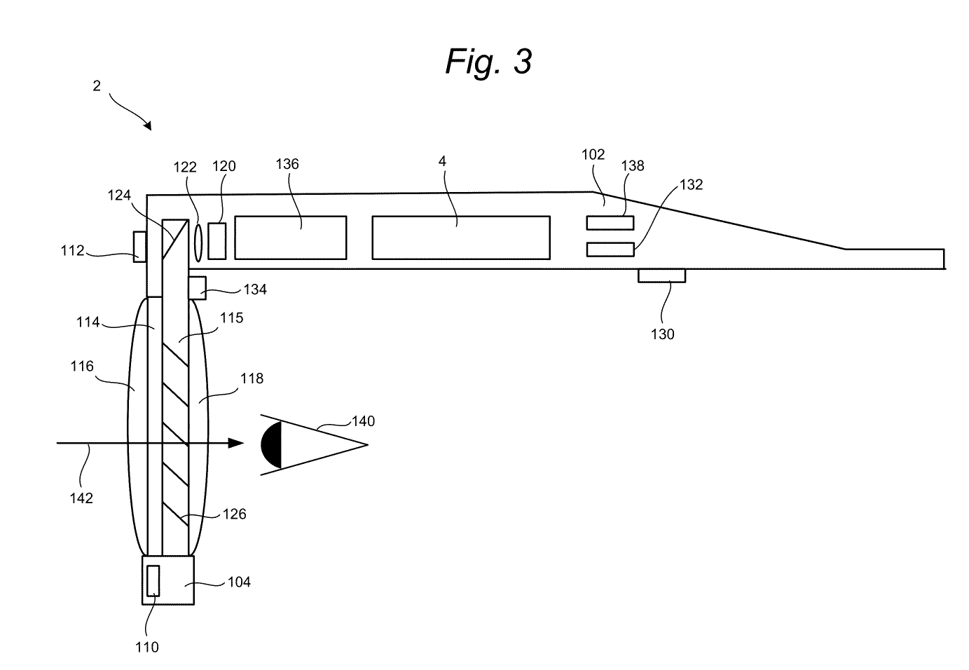

FIG. 1 illustrates a system 10 for providing a mixed reality experience by fusing virtual object 21 with real content within a user's FOV. FIG. 1 shows a multiple users 18a, 18b, 18c, each wearing a head mounted display device 2 for viewing virtual objects such as virtual object 21 from own perspective. There may be more or less than three users in further examples. As seen in FIGS. 2 and 3, a head mounted display device 2 may include an integrated processing unit 4. In other embodiments, the processing unit 4 may be separate from the head mounted display device 2, and may communicate with the head mounted display device 2 via wired or wireless communication.

Head mounted display device 2, which in one embodiment is in the shape of glasses, is worn on the head of a user so that the user can see through a display and thereby have an actual direct view of the space in front of the user. The use of the term “actual direct view” refers to the ability to see the real world objects directly with the human eye, rather than seeing created image representations of the objects. For example, looking through glass at a room allows a user to have an actual direct view of the room, while viewing a video of a room on a television is not an actual direct view of the room. More details of the head mounted display device 2 are provided below.

The processing unit 4 may include much of the computing power used to operate head mounted display device 2. In embodiments, the processing unit 4 communicates wirelessly (e.g., WiFi, Bluetooth, infra-red, or other wireless communication means) to one or more hub computing systems 12. As explained hereinafter, hub computing system 12 may be provided remotely from the processing unit 4, so that the hub computing system 12 and processing unit 4 communicate via a wireless network such as a LAN or WAN. In further embodiments, the hub computing system 12 may be omitted to provide a mobile mixed reality experience using the head mounted display devices 2 and processing units 4.

The head mounted display device 2, either by itself or in conjunction with the hub computing system 12, may provide a mixed reality experience where one or more virtual images, such as virtual object 21 in FIG. 1, may be mixed together with real world objects in a scene. FIG. 1 illustrates examples of a plant 23 or a user's hand 23 as real world objects appearing within the user's FOV.

FIGS. 2 and 3 show perspective and side views of the head mounted display device 2. FIG. 3 shows the right side of head mounted display device 2, including a portion of the device having temple 102 and nose bridge 104. Built into nose bridge 104 is a microphone 110 for recording sounds and transmitting that audio data to processing unit 4, as described below. At the front of head mounted display device 2 is room-facing video camera 112 that can capture video and still images. Those images are transmitted to processing unit 4, as described below.

A portion of the frame of head mounted display device 2 will surround a display (that includes one or more lenses). In order to show the components of head mounted display device 2, a portion of the frame surrounding the display is not depicted. The display includes a light-guide optical element 115, opacity filter 114, see-through lens 116 and see-through lens 118. In one embodiment, opacity filter 114 is behind and aligned with see-through lens 116, light-guide optical element 115 is behind and aligned with opacity filter 114, and see-through lens 118 is behind and aligned with light-guide optical element 115. See-through lenses 116 and 118 are standard lenses used in eye glasses and can be made to any prescription (including no prescription). Light-guide optical element 115 channels artificial light to the eye. More details of opacity filter 114 and light-guide optical element 115 are provided in U.S. Published Patent Application No. 2012/0127284, entitled, “Head-Mounted Display Device Which Provides Surround Video,” which application published on May 24, 2012.

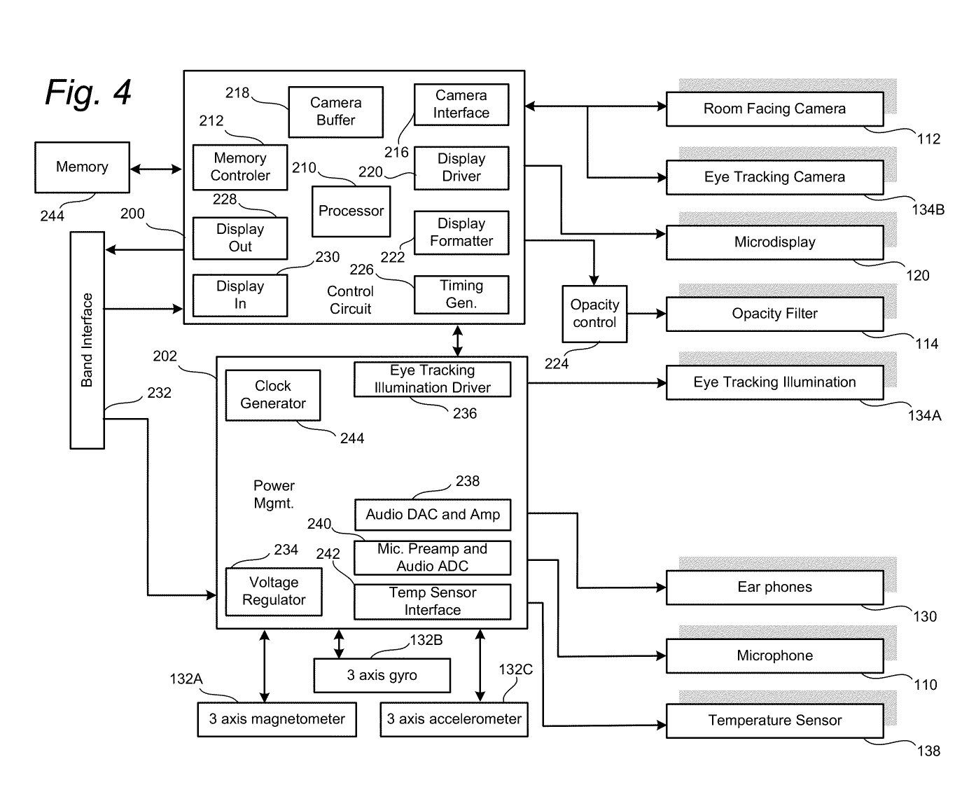

Control circuits 136 provide various electronics that support the other components of head mounted display device 2. More details of control circuits 136 are provided below with respect to FIG. 4. Inside or mounted to temple 102 are ear phones 130, inertial measurement unit 132 and temperature sensor 138. In one embodiment shown in FIG. 4, the inertial measurement unit 132 (or IMU 132) includes inertial sensors such as a three axis magnetometer 132A, three axis gyro 132B and three axis accelerometer 132C. The inertial measurement unit 132 senses position, orientation, and sudden accelerations (pitch, roll and yaw) of head mounted display device 2. The IMU 132 may include other inertial sensors in addition to or instead of magnetometer 132A, gyro 132B and accelerometer 132C.

Microdisplay 120 projects an image through lens 122. There are different image generation technologies that can be used to implement microdisplay 120. For example, microdisplay 120 can be implemented in using a transmissive projection technology where the light source is modulated by optically active material, backlit with white light. These technologies are usually implemented using LCD type displays with powerful backlights and high optical energy densities. Microdisplay 120 can also be implemented using a reflective technology for which external light is reflected and modulated by an optically active material. The illumination is forward lit by either a white source or RGB source, depending on the technology. Digital light processing (DLP), liquid crystal on silicon (LCOS) and Mirasol® display technology from Qualcomm, Inc. are all examples of reflective technologies which are efficient as most energy is reflected away from the modulated structure and may be used in the present system. Additionally, microdisplay 120 can be implemented using an emissive technology where light is generated by the display. For example, a PicoP™ display engine from Microvision, Inc. emits a laser signal with a micro mirror steering either onto a tiny screen that acts as a transmissive element or beamed directly into the eye (e.g., laser).

Light-guide optical element 115 transmits light from microdisplay 120 to the eye 140 of the user wearing head mounted display device 2. Light-guide optical element 115 also allows light from in front of the head mounted display device 2 to be transmitted through light-guide optical element 115 to eye 140, as depicted by arrow 142, thereby allowing the user to have an actual direct view of the space in front of head mounted display device 2 in addition to receiving a virtual image from microdisplay 120. Thus, the walls of light-guide optical element 115 are see-through. Light-guide optical element 115 includes a first reflecting surface 124 (e.g., a mirror or other surface). Light from microdisplay 120 passes through lens 122 and becomes incident on reflecting surface 124. The reflecting surface 124 reflects the incident light from the microdisplay 120 such that light is trapped inside a planar substrate comprising light-guide optical element 115 by internal reflection. After several reflections off the surfaces of the substrate, the trapped light waves reach an array of selectively reflecting surfaces 126. Note that one of the five surfaces is labeled 126 to prevent over-crowding of the drawing. Reflecting surfaces 126 couple the light waves incident upon those reflecting surfaces out of the substrate into the eye 140 of the user. More details of a light-guide optical element can be found in United States Patent Publication No. 2008/0285140, entitled “Substrate-Guided Optical Devices,” published on Nov. 20, 2008.

In accordance with aspects of the present technology, the head mounted display device 2 may also include a system for locating and tracking the position of the user's eyes. This system includes an eye position and tracking assembly 134 (FIG. 3), which has an eye tracking illumination device 134A and eye tracking sensor 134B (FIG. 4). In one embodiment, eye tracking illumination device 134A includes one or more infrared (IR) emitters, which emit IR light toward the eye. In one embodiment, eye tracking sensor 134B includes one or more cameras that sense the reflected IR light. Alternatively, eye tracking sensor 134B may be an RGB or depth sensor. There may be multiple sensors 134B in embodiments.

The position of a user's eyes, and the pupils within the eyes, can be identified by known imaging techniques which detect the reflection of the cornea. For example, see U.S. Pat. No. 7,401,920, entitled “Head Mounted Eye Tracking and Display System”, issued Jul. 22, 2008. Such a technique can locate a position of the center of the eye relative to the tracking sensor 134B. In embodiments, there may be a separate eye position and tracking assembly 134 for each of the left and right eyes so that a user's IPD may be determined. In further embodiments, there may be a single eye position and tracking assembly 134 identifying the center of either the left or right eye.

In one embodiment, the system will use four IR LEDs and four IR photo detectors in rectangular arrangement so that there is one IR LED and IR photo detector at each corner of the lens of head mounted display device 2. Light from the LEDs reflect off the eyes. The amount of infrared light detected at each of the four IR photo detectors determines a position of the eye relative to the sensor 134B, as well as the pupil direction. In particular, the amount of white versus black in the eye will determine the amount of light reflected off the eye for that particular photo detector. Thus, the photo detector will have a measure of the amount of white or black in the eye. From the four samples, the system can determine the direction of the eye.

Another alternative is to use four infrared LEDs as discussed above, but one infrared CCD on the side of the lens of head mounted display device 2. The CCD will use a small mirror and/or lens (fish eye) such that the CCD can image up to 75% of the visible eye from the glasses frame. The CCD will then sense an image and use computer vision to find the image, much like as discussed above. Thus, although FIG. 3 shows one assembly with one IR transmitter, the structure of FIG. 3 can be adjusted to have four IR transmitters and/or four IR sensors. More or less than four IR transmitters and/or four IR sensors can also be used.

Another embodiment for tracking the direction of the eyes is based on charge tracking. This concept is based on the observation that a retina carries a measurable positive charge and the cornea has a negative charge. Sensors are mounted by the user's ears (near earphones 130) to detect the electrical potential while the eyes move around and effectively read out what the eyes are doing in real time. This provides both the position of a user's eyes relative to the head mounted display device, and the position of the user's pupils. Other embodiments for determining the position of the user's eyes relative to the head mounted display device can also be used.

Using any of the above-described embodiments, the eye position and tracking system 134 is able to determine a position of the left and right eyes relative to a position of the eye position and tracking system 134. Using the known position and geometry of the system 134 relative to the optical elements 115, the position of the optical elements 115 relative to the left and right eyes is also known. This position includes a relative position of the eyes and the optical elements along the x-axis (e.g., horizontal positioning). This position includes a relative position of the eyes and optical elements along the y-axis (e.g., vertical positioning). And this position includes a relative position of the eyes and optical elements along the z-axis (e.g., a distance between the eyes and optical elements).

In addition to position, it is also advantageous to determine the angular orientation (pitch, yaw and roll) of the optical elements 115 relative to the left and right eyes. For this purpose, the eye position and tracking assembly 134 also determines a center of each eye, and an eye vector straight out from the center of the eye.

The eye center may be determined a number of ways. Where sensor 134B captures an image of the eye (either as a color image and/or as a depth image), the image may be analyzed to determine the eye center. For example, an image sensor may examine the corneal surface, and from that, determine major axes and the corneal center. In a further embodiment, the image sensor may examine other features of the eyes, including pupil, sclera (white portions of the eye) and/or eye lashes. Other features of the face such as brow, nose and nose bridge may further be imaged and used to determine the centers of the left and right eyes.

Examples including IR transmitters/receivers may also determine the center of the eye and an eye vector straight out from the center. For example, where there are multiple IR transmitters/receivers, such as four, each of these components may measure the amount of sclera in the eye they detect. These four independent values may be determined and compared. When each measures the same amount of sclera in the eye, the eye is centered (looking straight forward), and the eye vector may be taken perpendicularly straight out from the pupil. This position may either be found when each IR transmitter/receiver measure the same amount of sclera in the eye, or it may be extrapolated from a measurement where the four transmitter/receiver pairs measure different values of sclera in the eye.

As noted above, each eye may its own position and tracking assembly 134, and a separate eye vector may be determined for each. Alternatively, it may be assumed that the eyes are symmetric and move together, and a single eye vector may be determined and used for both eyes.

FIG. 3 shows half of the head mounted display device 2. A full head mounted display device would include another set of see-through lenses, another opacity filter, another light-guide optical element, another microdisplay 120, another lens 122, room-facing camera 112, eye position and tracking assembly 134, micro display, earphones, and temperature sensor.

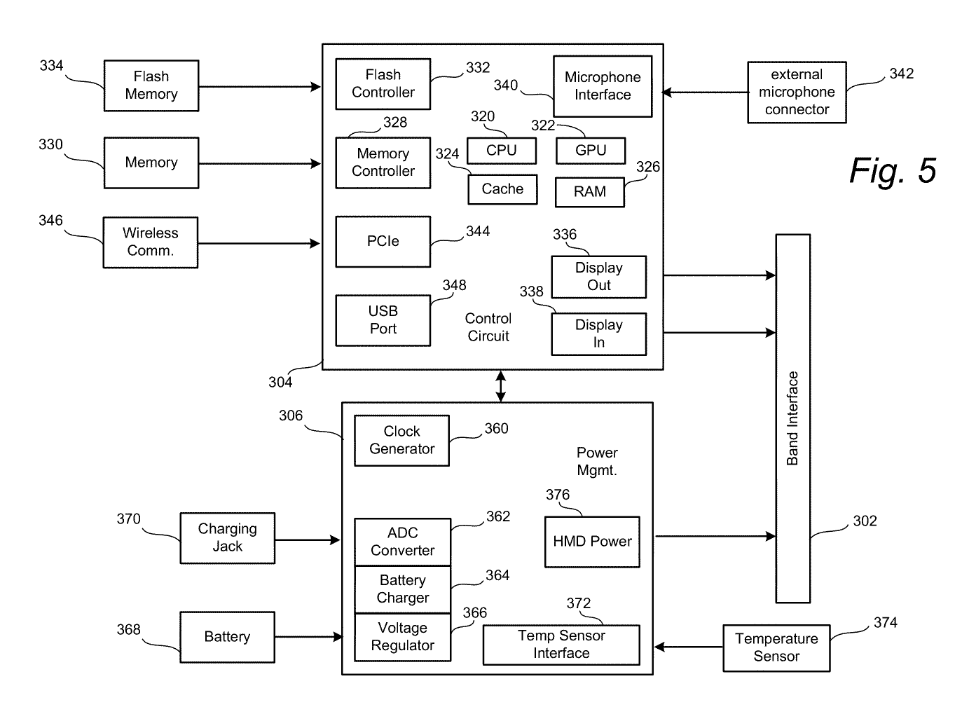

FIG. 4 is a block diagram depicting the various components of head mounted display device 2. FIG. 5 is a block diagram describing the various components of processing unit 4. Head mounted display device 2, the components of which are depicted in FIG. 4, is used to provide a mixed reality experience to the user by fusing one or more virtual images seamlessly with the user's view of the real world. Additionally, the head mounted display device components of FIG. 4 include many sensors that track various conditions. Head mounted display device 2 will receive instructions about the virtual image from processing unit 4 and will provide the sensor information back to processing unit 4. Processing unit 4, the components of which are depicted in FIG. 4, will receive the sensory information from head mounted display device 2.

Using that information and possibly information from hub computing system 12, processing unit 4 may determine where and when to provide a virtual image to the user and send instructions accordingly to the head mounted display device of FIG. 4. As explained hereinafter, using information from the eye position and tracking assembly 134, the processing unit 4 may additionally determine the position of the head mounted display device 2 relative to the eyes of a user, and in particular any misalignment of the optical elements 115 with the left and right eyes. This information may be used to provide precise feedback to the user on how to adjust head mounted display device 2 so as to provide centered, optimal alignment of the optical elements 115 with the user's eyes.

Some of the components of FIG. 4 (e.g., room-facing camera 112, eye tracking sensor 134B, microdisplay 120, opacity filter 114, eye tracking illumination 134A, earphones 130, and temperature sensor 138) are shown in shadow to indicate that there are two of each of those devices, one for the left side and one for the right side of head mounted display device 2. FIG. 4 shows the control circuit 200 in communication with the power management circuit 202. Control circuit 200 includes processor 210, memory controller 212 in communication with memory 214 (e.g., D-RAM), camera interface 216, camera buffer 218, display driver 220, display formatter 222, timing generator 226, display out interface 228, and display in interface 230.

In one embodiment, all of the components of control circuit 200 are in communication with each other via dedicated lines or one or more buses. In another embodiment, each of the components of control circuit 200 is in communication with processor 210. Camera interface 216 provides an interface to the two room-facing cameras 112 and stores images received from the room-facing cameras in camera buffer 218. Display driver 220 will drive microdisplay 120. Display formatter 222 provides information, about the virtual image being displayed on microdisplay 120, to opacity control circuit 224, which controls opacity filter 114. Timing generator 226 is used to provide timing data for the system. Display out interface 228 is a buffer for providing images from room-facing cameras 112 to the processing unit 4. Display in interface 230 is a buffer for receiving images such as a virtual image to be displayed on microdisplay 120. Display out interface 228 and display in interface 230 communicate with band interface 232 which is an interface to processing unit 4.

Power management circuit 202 includes voltage regulator 234, eye tracking illumination driver 236, audio DAC and amplifier 238, microphone preamplifier and audio ADC 240, temperature sensor interface 242 and clock generator 244. Voltage regulator 234 receives power from processing unit 4 via band interface 232 and provides that power to the other components of head mounted display device 2. Eye tracking illumination driver 236 provides the IR light source for eye tracking illumination 134A, as described above. Audio DAC and amplifier 238 output audio information to the earphones 130. Microphone preamplifier and audio ADC 240 provides an interface for microphone 110. Temperature sensor interface 242 is an interface for temperature sensor 138. Power management circuit 202 also provides power and receives data back from three axis magnetometer 132A, three axis gyro 132B and three axis accelerometer 132C.

FIG. 5 is a block diagram describing the various components of processing unit 4. FIG. 5 shows control circuit 304 in communication with power management circuit 306. Control circuit 304 includes a central processing unit (CPU) 320, graphics processing unit (GPU) 322, cache 324, RAM 326, memory controller 328 in communication with memory 330 (e.g., D-RAM), flash memory controller 332 in communication with flash memory 334 (or other type of non-volatile storage), display out buffer 336 in communication with head mounted display device 2 via band interface 302 and band interface 232, display in buffer 338 in communication with head mounted display device 2 via band interface 302 and band interface 232, microphone interface 340 in communication with an external microphone connector 342 for connecting to a microphone, PCI express interface for connecting to a wireless communication device 346, and USB port(s) 348. In one embodiment, wireless communication device 346 can include a Wi-Fi enabled communication device, BlueTooth communication device, infrared communication device, etc. The USB port can be used to dock the processing unit 4 to hub computing system 12 in order to load data or software onto processing unit 4, as well as charge the processing unit 4. In one embodiment, CPU 320 and GPU 322 are the main workhorses for determining where, when and how to insert virtual three-dimensional objects into the view of the user. More details are provided below.

Power management circuit 306 includes clock generator 360, analog to digital converter 362, battery charger 364, voltage regulator 366, head mounted display power source 376, and temperature sensor interface 372 in communication with temperature sensor 374 (possibly located on the wrist band of processing unit 4). Analog to digital converter 362 is used to monitor the battery voltage, the temperature sensor and control the battery charging function. Voltage regulator 366 is in communication with battery 368 for supplying power to the system. Battery charger 364 is used to charge battery 368 (via voltage regulator 366) upon receiving power from charging jack 370. HMD power source 376 provides power to the head mounted display device 2.

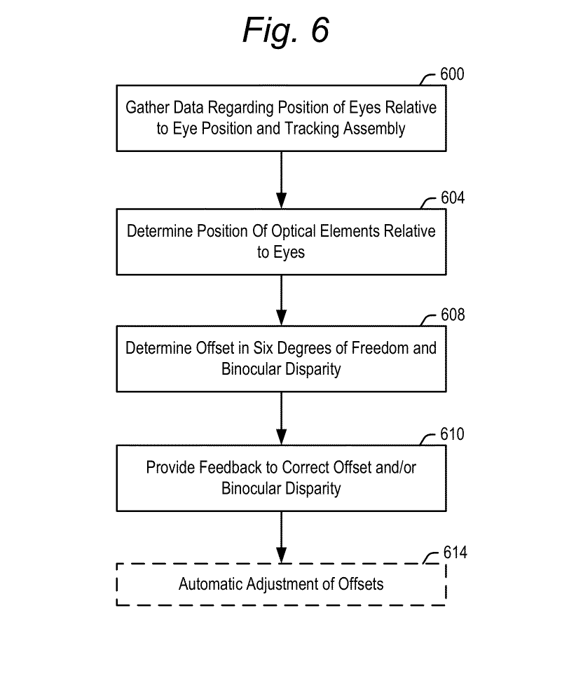

Using components such as the eye position and tracking assembly 134, the processing unit 4 is able to determine the centers of the user's eyes, and whether the optical elements 115 are properly centered in the optimal position over the user's eyes. Referring now to the flowchart of FIG. 6, in a step 600, the processing unit 4 may gather data regarding a position of the eye position in tracking assembly 134 relative to the user's eyes. Next, in a step 604, the processing unit 4 may determine the position of the optical elements 115 relative to the user's eyes. In particular, both the eye position and tracking assembly 134 and the optical elements 115 are fixedly mounted to the frame of the head mounted display device 2 in a known geometry to each other. The processing unit 4 is able to use this known geometry to translate distances and angular orientations between the eye position and tracking assembly 134 and the user's eyes to distances and angular orientations between the optical elements 115 and the user's eyes.

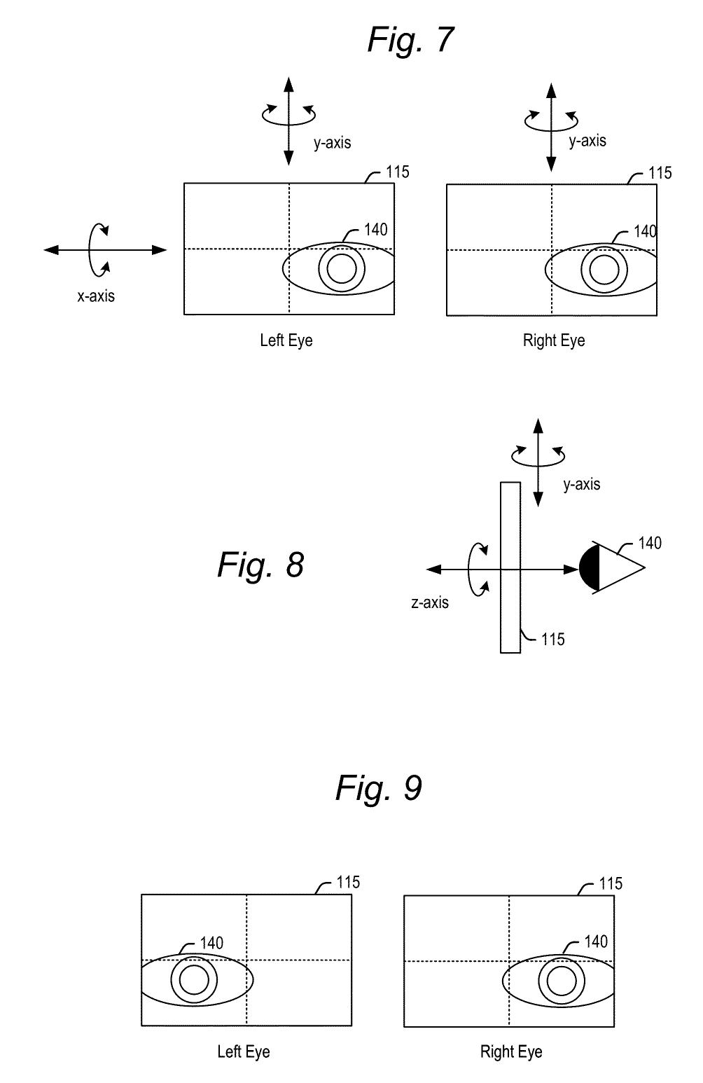

Using this information, the processing unit 4 is able to determine linear and angular offsets between respective optical elements 115 and the user's left and right eyes in step 608. These offsets may be determined in six degrees of freedom. As shown in FIGS. 7 and 8, the processing unit 4 is able to determine the x axis alignment, e.g., horizontally, between the optical elements 115 and the user's eyes; the y axis alignment, e.g., vertically, between the optical elements 115 and the user's eyes; and the z axis alignment, e.g., the distance between the optical elements 115 and the user's eyes.

Similarly, the processing unit 4 is able to determine a pitch, yaw and roll of the optical elements 115 relative to the user's eyes. For example, using the eye vector as determined above, the processing unit 4 is able to determine the pitch of the optical elements 115, i.e., rotation about the x axis, and the yaw of the optical elements 115, i.e., rotation about the y axis. As roll of an optical element is about the eye vector from the left or right eye, roll may be determined using information in addition to the eye vector. For example, roll may be determined by examining the eye vectors from both the left and right eyes.

It is understood that additional imaging devices may be provided as part of the head mounted display device 2 to provide additional information regarding pitch and yaw and roll to enable precise determination of the positioning of the optical elements 115 relative to the user's eyes, and a particular any offset in six degrees of freedom. As each eye can have its own dedicated eye position and tracking assembly 134, offset of the optical elements 115 for both the left and right eyes can be determined in twelve degrees of freedom.

In addition to linear offset along the x, y and/or z axes, and rotational offset around the x, y and/or z axes, step 608 may further include the step of determining any offset in binocular disparity requiring an adjustment in the IPD of the respective optical elements 115. In particular, some head mounted display devices may have a variable IPD, which is adjustable depending on the distance between a user's pupils. In such instances, as shown in FIG. 9, using the known center of the left and right eyes, processing unit 4 may determine any horizontal misalignment along the X axis between the IPD of the user and the center-to-center distance between optical elements 115.

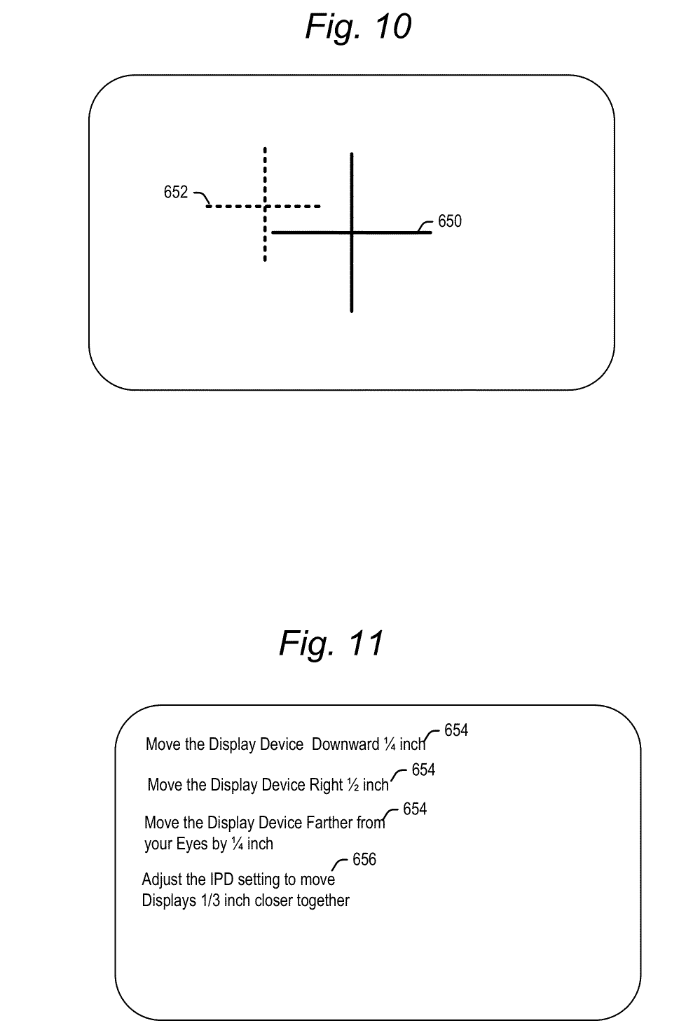

Once all offsets have been determined, the head mounted display device 2 may further provide feedback to user in step 610 regarding precise adjustments that can be made to optimally center the head mounted display device 2 with respect to the user's eyes. In one example, the processing unit 4 may include a software feedback routine for providing visible and/or auditory feedback to the user via head mounted display device 2 regarding any offset determined by the processing unit 4. The feedback routine and provide feedback in a wide variety of ways via the head mounted display device 2. For example, FIG. 10 illustrates a view through the head mounted display device 2 including virtual reference alignment crosshairs 650 and virtual actual alignment crosshairs 652. The reference alignment crosshairs 650 may represent an optimally aligned and centered position of the head mounted display device 2 on the user's eyes. The actual alignment crosshairs 652 may represent the actual position of the head mounted display device 2 and the degree of offset along both the vertical and horizontal axes.

The user may manually adjust the head mounted display device 2 to move it horizontally and vertically until the actual alignment crosshairs 652 alignment with reference alignment crosshairs 650. At this point, the head mounted display device will be correctly positioned on the user's head. As a user moves the head mounted display device 2, the actual alignment crosshairs 62 will move to show the user's progress. Thus, the virtual crosshairs 650, 652 provide a closed loop feedback system indicating to the user the adjustment of the head mounted display device 2.

Instead of or in addition to graphical indications of alignment, visual instructions may be provided to the user and how to adjust the head mounted display device 2. Such an example is shown in FIG. 11, which includes visual instructions 654 on how to adjust the head mounted display device 2. Such instructions could have additionally or alternatively included instructions on how to rotate the head mounted display device 2 to properly align it with the user's eyes. As a user adjusts the head mounted display device 2 per the instructions, the amounts shown for the adjustment may change to show the user's progress. Thus, the visual instructions 654 provide a closed loop feedback system indicating to the user the adjustment of the head mounted display device 2. The instructions shown in FIG. 11 could additionally or alternatively be audible.

As indicated above, in some examples, the head mounted display device 2 may have an adjustable mechanism to accommodate different IPD settings. The feedback routine of the processing unit 4 may further provide visual and/or auditory feedback instructing the user and how to adjust the distance between optical element 115 to correctly provide the IPD setting. For example, FIG. 11 also shows an instruction 656 for adjusting the IPD setting for the head mounted display device 2.

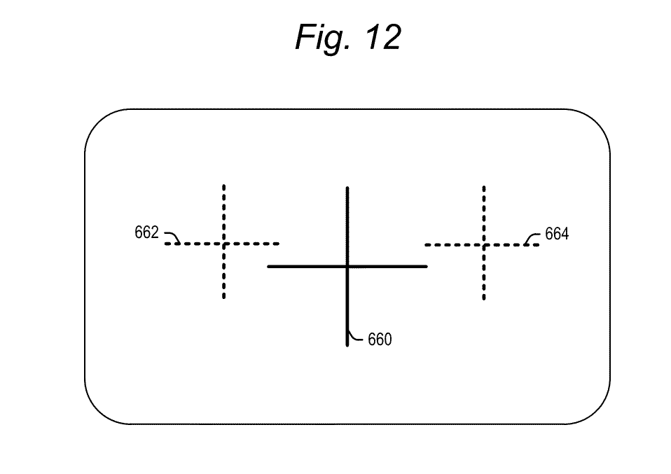

FIG. 12 shows a further alternative including virtual reference alignment crosshairs 660 and virtual IPD adjustment crosshairs 662, 664. As described above, a user can adjust the distance between the optical elements 115 using the adjustable mechanism on the head mounted display device 2 until adjustment crosshairs 662, 664 come together over reference alignment crosshairs 660. The graphical IPD adjustment shown in FIG. 12 can be combined with the horizontal/vertical adjustment of FIG. 10.

In each of the feedback scheme shown in FIGS. 10-12, the feedback virtual crosshairs or instructions may be displayed over virtual content, for example from an application with which a user is engaged at the time the feedback is provided. In further embodiments, switching into feedback mode may temporarily halt the display of other virtual objects, which may resume once the feedback has received in the head mounted display device 2 has been adjusted.

In embodiments, a user may manually adjust the head mounted display device 2 upon receipt of the feedback in a closed loop feedback system. In a further embodiment, adjustment of the head mounted display device 2 may occur automatically as indicated in step 614 in FIG. 6 (which is shown in dashed lines as it may or may not take place). The may be two methods of automatic adjustment. In a first mode, adjustments to be made in software. In a second mode, physical changes may be made to the head mounted display device using mechanical actuators. These modes are explained in greater detail below.

Where for example the adjusted to be made is to the distance between optical elements 115 to adjust for optimal IPD, this adjustment to be made using software instead of physically adjusting the distance between the optical elements 115. In particular, the display from micro display 120 to the respective optical elements 115 may be adjusted by the processing unit 4 to automatically adjust optimal IPD using software commands from the processing unit 4. Similar software adjustments may be used to automatically compensate for linear and/or angular offsets with respect to the x, y and z axes.

Alternatively, closed loop servo actuators may be provided on the head mounted display device 2 for adjusting optical elements 115 in response to feedback from the processing unit 4. For example, where there is adjustment mechanism for IPD adjustment, adjustment mechanism may be driven by a servo motor which physically adjusts the distance between optical element 115 over a predefined range in response to feedback regarding the binocular disparity offset. It is conceivable that other servomotors be provided to adjust the head mounted display device 2 to automatically compensate for linear and/or angular offsets with respect to the x, y and z axes.

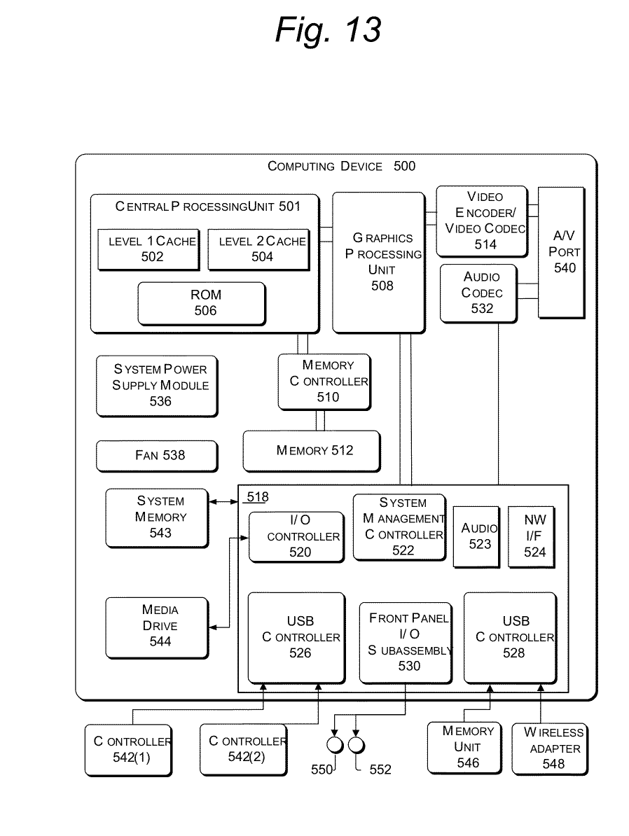

FIG. 13 illustrates an example embodiment of a computing system that may be used to implement the hub computing system 12 or other processors disclosed herein. As shown in FIG. 13, the computing system 500 has a central processing unit (CPU) 501 having a level 1 cache 502, a level 2 cache 504, and a flash ROM (Read Only Memory) 506. The level 1 cache 502 and a level 2 cache 504 temporarily store data and hence reduce the number of memory access cycles, thereby improving processing speed and throughput. CPU 501 may be provided having more than one core, and thus, additional level 1 and level 2 caches 502 and 504. The flash ROM 506 may store executable code that is loaded during an initial phase of a boot process when the computing device 500 is powered on.

A graphics processing unit (GPU) 508 and a video encoder/video codec (coder/decoder) 514 form a video processing pipeline for high speed and high resolution graphics processing. Data is carried from the graphics processing unit 508 to the video encoder/video codec 514 via a bus. The video processing pipeline outputs data to an A/V (audio/video) port 540 for transmission to a television or other display. A memory controller 510 is connected to the GPU 508 to facilitate processor access to various types of memory 512, such as, but not limited to, a RAM (Random Access Memory).

The computing device 500 includes an I/O controller 520, a system management controller 522, an audio processing unit 523, a network interface 524, a first USB host controller 526, a second USB controller 528 and a front panel I/O subassembly 530 that are preferably implemented on a module 518. The USB controllers 526 and 528 serve as hosts for peripheral controllers 542(1)-542(2), a wireless adapter 548, and an external memory device 546 (e.g., flash memory, external CD/DVD ROM drive, removable media, etc.). The network interface 524 and/or wireless adapter 548 provide access to a network (e.g., the Internet, home network, etc.) and may be any of a wide variety of various wired or wireless adapter components including an Ethernet card, a modem, a Bluetooth module, a cable modem, and the like.

System memory 543 is provided to store application data that is loaded during the boot process. A media drive 544 is provided and may comprise a DVD/CD drive, Blu-Ray drive, hard disk drive, or other removable media drive, etc. The media drive 544 may be internal or external to the computing device 500. Application data may be accessed via the media drive 544 for execution, playback, etc. by the computing device 500. The media drive 544 is connected to the I/O controller 520 via a bus, such as a Serial ATA bus or other high speed connection (e.g., IEEE 1394).

The system management controller 522 provides a variety of service functions related to assuring availability of the computing device 500. The audio processing unit 523 and an audio codec 532 form a corresponding audio processing pipeline with high fidelity and stereo processing. Audio data is carried between the audio processing unit 523 and the audio codec 532 via a communication link. The audio processing pipeline outputs data to the A/V port 540 for reproduction by an external audio user or device having audio capabilities.

The front panel I/O subassembly 530 supports the functionality of the power button 550 and the eject button 552, as well as any LEDs (light emitting diodes) or other indicators exposed on the outer surface of the computing device 500. A system power supply module 536 provides power to the components of the computing device 500. A fan 538 cools the circuitry within the computing device 500.

The CPU 501, GPU 508, memory controller 510, and various other components within the computing device 500 are interconnected via one or more buses, including serial and parallel buses, a memory bus, a peripheral bus, and a processor or local bus using any of a variety of bus architectures. By way of example, such architectures can include a Peripheral Component Interconnects (PCI) bus, PCI-Express bus, etc.

When the computing device 500 is powered on, application data may be loaded from the system memory 543 into memory 512 and/or caches 502, 504 and executed on the CPU 501. The application may present a graphical user interface that provides a consistent user experience when navigating to different media types available on the computing device 500. In operation, applications and/or other media contained within the media drive 544 may be launched or played from the media drive 544 to provide additional functionalities to the computing device 500.

The computing device 500 may be operated as a standalone system by simply connecting the system to a television or other display. In this standalone mode, the computing device 500 allows one or more users to interact with the system, watch movies, or listen to music. However, with the integration of broadband connectivity made available through the network interface 524 or the wireless adapter 548, the computing device 500 may further be operated as a participant in a larger network community. Additionally, computing device 500 can communicate with processing unit 4 via wireless adaptor 548.

Optional input devices (e.g., controllers 542(1) and 542(2)) are shared by gaming applications and system applications. The input devices are not reserved resources, but are to be switched between system applications and the gaming application such that each will have a focus of the device. The application manager preferably controls the switching of input stream, without knowing the gaming application's knowledge and a driver maintains state information regarding focus switches. Capture device 20 may define additional input devices for the device 500 via USB controller 526 or other interface. In other embodiments, hub computing system 12 can be implemented using other hardware architectures. No one hardware architecture is required.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. It is intended that the scope of the invention be defined by the claims appended hereto.

We claim:

1. A head mounted display device, comprising:
a display unit including optical elements;
a position and tracking assembly for sensing a position and angular orientation of the position and tracking assembly with respect to eyes of a wearer;
a processor coupled to the display unit and position and tracking assembly for determining a position and angular orientation of the optical elements relative to the eyes; and
a feedback routine executed by the processor for providing feedback to the wearer to adjust at least one of the position and orientation of the head mounted display device relative to the eyes based on the determination of misalignment from the processor.

2. The head mounted display of claim 1 wherein the position and tracking assembly senses misalignment of the position and tracking assembly with the wearer's eyes along a horizontal axis.

3. The head mounted display of claim 2 wherein the position and tracking assembly senses misalignment of the position and tracking assembly with respect to an inter-pupillary distance of the wearer's eyes.

4. The head mounted display of claim 1 wherein the position and tracking assembly senses misalignment of the position and tracking assembly with the wearer's eyes along a vertical axis.

5. The head mounted display of claim 1 wherein the position and tracking assembly senses misalignment of the position and tracking assembly with respect to a distance of the head mounted display from the wearer's eyes.

6. The head mounted display of claim 1 wherein the position and tracking assembly senses misalignment of the position and tracking assembly with respect to at least one of a pitch, yaw and roll of the head mounted display device with respect to the wearer's eyes.

7. The head mounted display of claim 1 wherein the position and tracking assembly includes one or more transmitters directed at an eye of the wearer and one or more receivers for receiving a transmission from the eye of the wearer.

8. The head mounted display of claim 1 wherein the position and tracking assembly includes an imaging device directed at an eye of the wearer for capturing an image of the eye of the wearer.

9. The head mounted display of claim 1 wherein the feedback routine generates at least one of visual and auditory feedback relating to a determined misalignment of the head mounted display device relative to the eyes of the wearer.

10. The head mounted display of claim 1 further comprising a software routine or mechanical actuator for automatically adjusting the head mounted display device in response to feedback from the feedback routine relating to a determined misalignment of the head mounted display device relative to the eyes of the wearer.

11. The head mounted display of claim 1 wherein the display unit displays virtual images to the optical elements.

12. A head mounted display device for providing a mixed reality experience in a space having an x-axis, a y-axis perpendicular to the x-axis and a z-axis perpendicular to the x and y axes, the head mounted display comprising:
a display unit including optical elements for displaying virtual images to eyes of a wearer;
a position and tracking assembly for sensing a position with respect to the x, y and z axes of the position and tracking assembly to the eyes, and an angular rotation with respect to rotation about the x, y and z axes an x-axis of the position and tracking assembly to the eyes;
a processor coupled to the display unit and position and tracking assembly for determining a position and angular orientation of the optical elements relative to the eyes; and
a feedback routine implemented by the processor for providing feedback to the user to adjust at least one of the position and orientation of the head mounted display relative to the eyes based on the determination from the processor.

13. The head mounted display of claim 12 wherein the feedback routine generates feedback in the form of virtual images displayed by the display unit.

14. The head mounted display of claim 13 wherein the virtual images are graphical images indicating an adjustment to correct a misalignment between the head mounted display device and the eyes.

15. The head mounted display of claim 13 wherein the virtual images are virtual words indicating an adjustment to correct a misalignment between the head mounted display device and the eyes.

16. The head mounted display of claim 13 wherein the optical elements are mounted in the head mounted display device for automatic adjustment with respect to the head mounted display device or each other.

17. A method for indicating misalignment of one or more optical elements of a head mounted display device with eyes of a wearer, the method comprising:
(a) determining misalignment of the optical elements to the eyes of the wearer, said misalignment determined by a processing device and an eye position and tracking assembly; and
(b) generating feedback providing information to the wearer regarding how to adjust one or more of the optical elements, the feedback displayed as one or more virtual images displayed to the optical elements.

18. The method of claim 17, wherein the step of determining misalignment of the optical elements to the eyes of the wearer comprises the step of determining misalignment of the optical elements to the eyes of the wearer in six degrees of freedom.

19. The method of claim 17, wherein the step of determining misalignment of the optical elements to the eyes of the wearer comprises the step of determining a position of the wearer's eyes and a center of the wearer's eyes.

20. The method of claim 17, wherein the step of generating feedback providing information to the wearer regarding how to adjust one or more of the optical elements comprises the step of displaying one of virtual graphical images to the user and displaying virtual words to the user providing instructions on how to correct misalignment of head mounted display device.
